(19) United States
(12) Patent Application Publication
(10) Pub. No.: US 2025/0158204 A1
(43) Pub. Date: May 15, 2025

(54) CLIP FOR THE ASSEMBLY OF BATTERY MODULES

(71) Applicant: SAFT, Levallois-Perret (FR)

(72) Inventors: Eric PASQUIER, SAINT-BENOÎT (FR); Hélène TRICOT, VALENCE EN POITOU (FR); Damien ROCHARD, SEVRES-ANXAUMONT (FR)

(73) Assignee: SAFT, Levallois-Perret (FR)

(21) Appl. No.: 18/838,849

(22) PCT Filed: Feb. 13, 2023
(86) PCT No.: PCT/EP2023/053463

§ 371 Date: Aug. 15, 2024

(30) Foreign Application Priority Data
Feb. 18, 2022 (FR) 2201467

(51) Int. Cl. H01M 50/262; H01M 50/213; H01M 50/258

(52) U.S. Cl. CPC H01M 50/262; H01M 50/213; H01M 50/258

(57) ABSTRACT

A connecting part for assembling two battery modules, said connecting part including: a first portion able to be inserted into a recess of a first retaining element of a first plurality of electrochemical cells forming part of a first battery module and a second portion able to be inserted into a recess of a second retaining element of a second plurality of electrochemical cells forming part of a second battery module, the first portion and the second portion having different dimensions, such that the first portion is not suitable for being inserted into the recess of the second retaining element and/or the second portion is not suitable for being inserted into the recess of the first retaining element, a device for preventing the removal of the connecting part after its insertion into a recess of one of the two retaining elements.

### TECHNICAL FIELD OF THE INVENTION

The technical field of this invention is that of devices for the assembly of battery modules.

### BACKGROUND OF THE INVENTION

A battery module, also referred to as a module in the remainder of the text, is formed by the association and electrical connection of several electrochemical cells. Series electrical connection of the electrochemical cells makes it possible to increase the voltage of the battery module. Parallel connection makes it possible to increase its capacity. Series connection of the cells makes it possible to increase the voltage of the battery module. The cells are secured within a module using one or more retaining means, also known as strapping or flanges.

Several modules can in turn be connected together in series and/or in parallel, thus making it possible to attain the values of voltage and quantity of electricity required to ensure the operation of an electrical device. The set of modules connected to one another constitutes a battery. In the aim of maximizing the energy density of the battery, the modules are generally adjoined to one another.

The document FR-A-2 562 170 describes a bonding jumper intended to mechanically assemble two modular elements, a wall of one of the modular elements being face to face with a wall of the other, one of these walls including an electrical connector intended to be connected to an additional connector located on the other wall. This jumper includes two identical branches completely secured to one another.

The branches have the same shape and the same dimensions. They are intended to be inserted into two identical cavities fashioned in the walls of the two modular elements. This type of jumper does not make it possible to help an operator suitably orient a number of modular elements. In addition, if the interlocking between the two modular elements is not perfect, due sometimes to a certain variability in the dimensions of the modular elements, mechanical stresses on the jumper may arise. As an electrical connection is made between the two modular elements, the presence of a clearance between the two modular elements must be avoided since it would impair the quality of the electrical connection. Finally, this type of jumper can quite easily come out of the cavities. Specifically, an operator can take out the jumper by hand by sliding it along the cavity. There is therefore a risk of one of the two modular elements sliding downward and becoming completely detached from the other modular element.

A connecting part is therefore sought which can simultaneously:
mechanically connect two battery modules;
help an operator to easily find the previously defined orientation of the two battery modules that are to be electrically connected, specifically in order to prevent, by “poka-yoke” effect via a simple mistake-proofing device, any undesirable or dangerous electrical connections from being made;
be used to assemble a plurality of modules even when the distance between two battery modules to be adjoined varies slightly and when there is a slight difference in height between these two modules;
not spontaneously disengage from a flange, unless a tool is used to puncture the connecting part.

Preferably, the connecting part must make it possible to assemble flanges whose outer surface is devoid of any excrescence. For example, it is desirable to use flanges whose lateral surface is devoid of any system comparable to a dovetail.

Preferably, the connecting part must serve as an attachment point for one or more electrical wires.

### SUMMARY OF THE INVENTION

This invention overcomes the abovementioned drawbacks by making provision for a connecting part for assembling two battery modules, said connecting part comprising:
a first portion able to be inserted into a recess of a first retaining element of a first plurality of electrochemical cells forming part of a first battery module and
a second portion able to be inserted into a recess of a second retaining element of a second plurality of electrochemical cells forming part of a second battery module, the first portion and the second portion having different dimensions, such that the first portion is not suitable for being inserted into the recess of the second retaining element and/or the second portion is not suitable for being inserted into the recess of the first retaining element,
a means for preventing the removal of the connecting part after its insertion into a recess of one of the two retaining elements.

According to an embodiment, the connecting part is composed of a material that does not conduct current, such as plastic.

According to an embodiment, the first portion comprises a part which is manually flexible and a part which is not manually flexible, the part which is manually flexible and the part which is not manually flexible respectively form a first and a second branch, the first and the second branch being at least partially separate, thus allowing a deformation of the part which is manually flexible with respect to the part which is not manually flexible.

According to an embodiment, the material forming the connecting part has a bending stiffness at the elastic limit at 23° C. as per the ISO standard ranging from 125 to 315 MPa.

According to an embodiment, a cross-section of the first portion is of circular or semi-circular or oval or semi-oval shape and a cross-section of the second portion is T-shaped.

According to an embodiment, a free end of the part which is manually flexible is tapered.

According to an embodiment, the means for preventing the removal of the connecting part is a protrusion located on the part which is manually flexible, suitable for snap-fitting against a shoulder of one of the retaining elements.

Another subject of the invention is a set comprising:
a first battery module equipped with at least a first retaining element serving to retain a first plurality of electrochemical cells and a second battery module equipped with at least a second retaining element serving to retain a second plurality of electrochemical cells,
a connecting part as described above, assembling the first retaining element with the second retaining element, the first portion being inserted into a recess of the first retaining element and the second portion being inserted into a recess of the second retaining element,
   the first portion being configured to not be able to be inserted into the recess of the second retaining element and/or the second portion being configured to not be able to be inserted into the recess of the first retaining element,
   there being a clearance between the first or the second portion of the connecting part and the recess into which the first or the second portion is inserted, this clearance allowing a displacement of one of the two battery modules with respect to the other, in the three dimensions of the space.

According to an embodiment, the clearance is of at least 0.15 mm and less than 1 mm in each of the three dimensions of the space.

According to an embodiment, the recess of the first retaining element has at least one dimension different from the recess of the second retaining element.

According to an embodiment, the recess of the first retaining element and the recess of the second retaining element extend along the longitudinal direction of the electrochemical cells, the shape of the cross-section of the recess of the first retaining element being different from the shape of the cross-section of the recess of the second retaining element.

According to an embodiment, the cross-section of the recess of the first retaining element is of circular or semi-circular or oval or semi-oval shape and the cross-section of the recess of the second retaining element is T-shaped.

According to an embodiment,
the first and the second retaining element cover a first end of the first plurality and of the second plurality of electrochemical cells respectively,
the first connecting part connects the first and the second retaining element located at the same first end of the electrochemical cells,
   the set further comprising:
a first and a second retaining element of the second end covering the opposite end of the first plurality and of the second plurality of electrochemical cells respectively,
a second connecting part connecting the first and the second retaining element of the second end, the second connecting part being as described above.

According to an embodiment, the first and the second connecting part each have a heel preventing the detachment of the first and of the second battery module.

According to an embodiment, the first and the second battery module each contain four electrochemical cells, the retaining elements being of square shape, with optionally rounded corners, the four sides of the square each receiving a recess.

According to an embodiment, two recesses located on two opposite sides of the square have different dimensions and shapes.

Finally, the invention also has the subject of a battery comprising at least one set as described above.

The connecting part is equivalently referred to in the remainder of the text by the term “clip”. The retaining element is equivalently referred to in the remainder of the text by the term “flange”.

### BRIEF DESCRIPTION OF THE FIGURES

Embodiments of the invention are described below in more detail with reference to the attached figures.

FIG. 1 is a front view of the clip according to the invention.

FIG. 2 is a bottom view of the clip of FIG. 1. The cross-section of the first portion of the clip is of circular shape. The cross-section of the second portion of the clip is T-shaped.

FIG. 3 is a bottom view of the assembly area between two modules. It particularly shows the clearance in a horizontal plane between one of the two portions of the clip (the “T”-shaped one) and the recess into which this portion is inserted.

FIG. 4 is a bottom view of two modules assembled by the clip according to the invention. It particularly shows that the cross-sections of the recesses made on two opposite edges of a flange are different.

FIG. 5a shows a longitudinal section view of the clip assembling two flanges disposed on the upper end of two modules.

FIG. 5b shows a longitudinal section view of a clip assembling two flanges disposed on the lower end of two modules. Note in FIGS. 5a and 5b the presence of a clearance between the heel of the clip and the inner wall of the flange, thus allowing the left module to move slightly in the vertical direction.

FIG. 6 shows a longitudinal section view of two modules assembled using a first clip connecting two flanges located on the upper end of two modules and a second clip connecting two flanges located on the lower end of the two modules.

FIG. 7 is a perspective view of an assembly of two modules. These latters have been assembled using a first clip connecting two flanges located on the upper end of the two modules and a second clip connecting two flanges located on the lower end of the two modules.

FIG. 8 is a perspective view of an assembly of three modules. A third module has been added to the two modules of FIG. 7. FIG. 8 in particular shows the addition of clips in the recesses of the flanges located on the lower end of the second and third modules.

FIG. 9 is a perspective view of an assembly in which a 4^{th} module is adjoined to the three modules of FIG. 8.

FIG. 10 is a perspective view of an assembly of four modules. It shows, in particular, the placement of two clips on the upper flange of the 4^{th} module.

FIG. 11 is a perspective view showing the assembly of the four modules of FIG. 10 after the placement of all the clips on the upper flanges of the modules.

### DESCRIPTION OF THE EMBODIMENTS OF THE INVENTION

### Description of the Clip

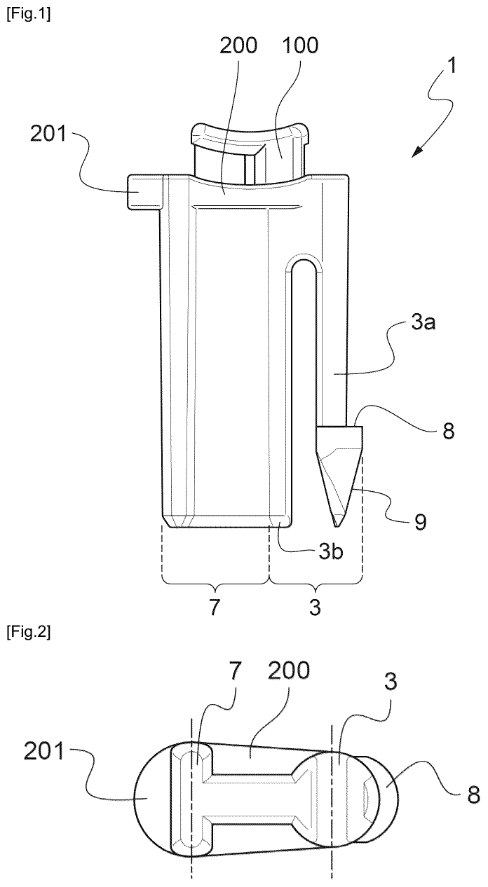

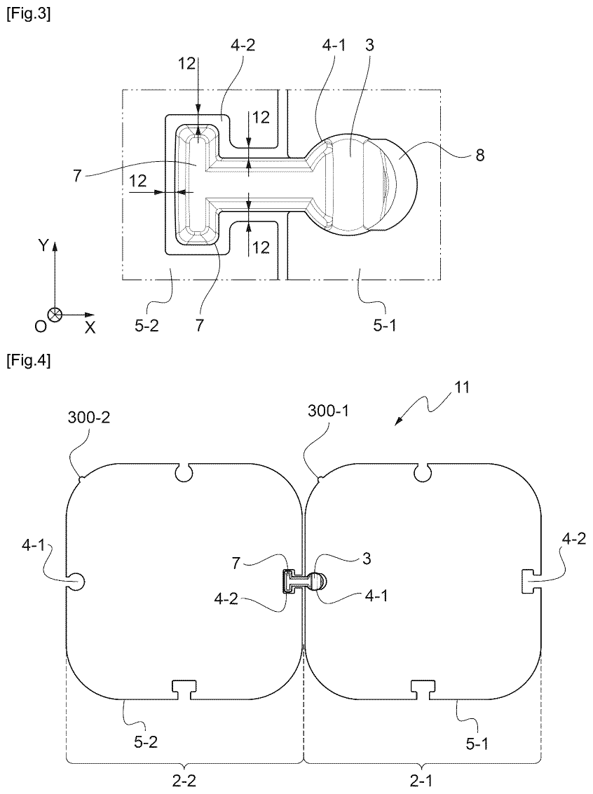

The clip will be described in relation to FIGS. 1 and 3. The clip (1) typically comprises a heel (200, 201) from which extend:
a first portion (3) intended to be inserted into a recess (4-1) of a first flange (5-1) of a first plurality of electrochemical cells forming part of a first battery module and
a second portion (7) intended to be inserted into a recess (4-2) of a second flange (5-2) of a second plurality of electrochemical cells forming part of a second battery module.

The first and the second portion of the clip extend in a direction perpendicular to the longitudinal axis of the heel. They are substantially parallel to one another and are adjoined to one another over their entire length.

The first portion (3) comprises a flexible part (3a) and a non-flexible part (3b) secured to the second portion (7) of the clip. The term “flexible” should be understood to mean “manually flexible”. The flexible part (3a) and the non-flexible part (3b) form two partially separate branches. The fact that the two branches are only partially connected to one another makes it possible to give the branch (3a) a certain amount of flexibility in relation to the non-flexible branch (3b). In addition, the flexible branch (3a) has a length very much greater than its thickness, which contributes to its elastic deformation during the placement of the clip in the flange. It is both branches (3a, 3b) of the first portion (3) of the clip which are inserted into the recess (4-1) of the first flange (5-1) of the first plurality of electrochemical cells and not only the flexible branch (3a) of the first portion.

The heel, the first and the second portion of the clip are preferably obtained by molding a plastic material. It is also possible, although less preferable, to weld or bond the first portion, the second portion and the heel. A plastic material is better than a metallic material due to its electrically insulating nature. Specifically, the clip does not participate in the electrical connection between two modules but only in their mechanical assembly. Plastic materials suitable for manufacturing the clip are:
polyetheretherketones, such as Victrex® PEEK 150G,
polyamide-imides, such as Torlon® 5030,
polyphenylene sulfides, such as Ryton® R-4 and Techtron® HPV,
polyamides (Nylon®),
polyethylene, polypropylene and their copolymers, although these polymers have inferior mechanical properties to the other polymers mentioned.

Preferably, the plastic material is a polyetheretherketone, (PEEK), such as Victrex® PEEK 150G. Elastomers are less suitable as the component material of the clip. The material of which the clip is composed can be chosen to observe a positive margin between the elastic bending limit of the material divided by the safety coefficient (e.g. 1.25 in the case of the elastic range) and the applied bending stress. This can range from 100 to 250 MPa. In this special case, one may choose a material having a bending stiffness at the elastic limit at 23° C. as per ISO standard 178 ranging from 125 to 315 MPa.

The end of the flexible branch (3a) is preferably tapered (9). The insertion of the clip into a recess of a flange is thereby facilitated.

The clip comprises a means for preventing its removal after its insertion into one of the flanges. Thus, the clip, once inserted into the flange, cannot spontaneously come back out of the flange. It is ungrippable and manually unremovable. This means can be a protrusion (8) intended to interact with a shoulder (10) for which provision is made inside the flange. Preferably, the protrusion is located on the flexible branch (3a) of the clip. The clip is mounted by snap-fitting of the protrusion on the shoulder (10). The insertion of the clip can be done by an operator without him having to use a specific tool.

The mistake-proofing function offered by the clip allows the modules to be mechanically assembled by putting the lateral surfaces of the flanges in contact in a single configuration combining compatibility of interface and orientation, which makes it possible, during subsequent wiring of the modules, to avoid any unwanted electrical connection between two adjacent modules. This mistake-proofing function is obtained by choosing a first portion and a second portion of the clip having cross-sections of different shapes or dimensions. FIG. 2 represents a bottom view of the clip of FIG. 1. The cross-section of the first portion (3) is of circular shape while the cross-section of the second portion (7) is T-shaped. The shape of the cross-section of the first and second portions of the clip is not limited to a circular or T-shape. Other shapes may be envisioned, such as an oval, triangular, square, trapezoid or U-shape, on condition that the shape of the cross-section of the first portion is different from that of the second portion. FIG. 2 also shows that the heel (200, 201) extends in a direction perpendicular to the direction in which the first and the second portion of the clip extend. The heel serves as an end stop during the insertion of the clip into the flanges as will be explained hereinafter. FIG. 2 also shows the protrusion (8) which allows one of the branches to snap-fit into the recess of a flange and lock the clip in the flange. FIG. 1 shows that the surface of the heel intended to be oriented toward the outside of the module may include a hooking means making it possible to pass a coupling through it, which coupling retains one or more electrical wires on the clip. The hooking means can be a cell connector (100). The coupling can be a plastic cable tie of Rilsan type passing around the cell connector or through the cell connector.

### Description of a Module and Flanges.

A module consists of a unit structure of fixed volume delivering a voltage and a given quantity of energy. The voltage and the quantity of energy available depend on the method of electrical connection of the electrochemical cells. The electrochemical cells are generally regularly distributed around a central axis and are connected to one another by means of metallic bars. The central axis serves as a means for attaching electrochemical cells to one another. It also serves to attach the module on a support. This support thus unites all the different modules of the battery. The module generally comprises an electronic control and management circuit intended to measure the state of charge and/or the state of health of the cells, particularly by means of the voltage or current measurements taken individually, cell by cell, or taken from a group of cells.

Configurations involving 3, 4 or 5 electrochemical cells per module are the most beneficial. The configuration with 4 electrochemical cells is optimal from the point of view of compactness while complying with the mechanical, thermal and electrical limitations. The format of the electrochemical cells is not particularly limited. These can be of cylindrical or prismatic shape, preferably cylindrical. The technology of the electrochemical cells is not limited.

These can be of lithium-ion type. They can be of primary type (“cell” and consequently non-rechargeable) or of secondary type (“accumulator”, and consequently rechargeable).

The electrochemical cells are secured within one and the same module using one or more flanges. A single flange can totally or at least partially surround the lateral wall of each of the electrochemical cells. It can be disposed in the vicinity of the middle of the length (or of the height) of the electrochemical cells. However, for better retainment of the cells, two flanges are preferably used. They are each disposed on one of the ends of the electrochemical cells of the module.

A flange is composed of a plate comprising over its largest surface a plurality of cavities intended to interlock with the bottom of the container of the electrochemical cells and/or with the cover of the electrochemical cells. Each cavity follows the shape of the cross-section of the container or of the cover of the electrochemical cells. The cross-section is preferably circular. Besides the function of assembly of the cells within a module, the flange makes it possible to shim the electrochemical cells to avoid them undergoing the harmful effects of the vibrations. The flange is generally made of an electrically insulating material, preferably a plastic material. It is generally obtained by molding a plastic material.

### Assembly of the Flanges of Two Modules Adjoined Using the Clip

Each flange has a lateral surface defined as the surface perpendicular to the largest surface of the flange. This lateral surface includes one or more recesses which extend over at least a portion of the height of the lateral surface of the flange and which open onto the largest surface of the flange.

The adjoining of two modules brings the two recesses of the two flanges face-to-face to form a common groove into which the clip is then inserted.

The electrical connection of two modules in an undesirable configuration is prevented (mistake-proofing function) by putting face-to-face the lateral surfaces of the two flanges in which two recesses have cross-sections of different shapes or dimensions. The cross-section of the recess of a flange of one of the two modules differs in its shape or in its dimensions from the cross-section of the recess of a flange of a second module put face-to-face therewith.

The first portion and the second portion of the clip are each inserted into the recess of one of the two flanges. The clip is inserted either through the top of the module for the flange in the upper position, i.e. covering the upper end of the electrochemical cells, or through the bottom of the module for the flange in the lower position, i.e. covering the lower end of the electrochemical cells.

The clip makes it possible to fulfil the mistake-proofing function since the shape of the cross-section of the first portion of the clip is complementary with that of the cross-section of the recess of a first flange into which the clip is intended to be inserted. Similarly the shape of the cross-section of the second portion of the clip is complementary with that of the cross-section of the recess of a second flange into which the clip is intended to be inserted.

The protrusion located on one of the two branches of the clip makes it possible to lock the position of the clip in one of the two flanges.

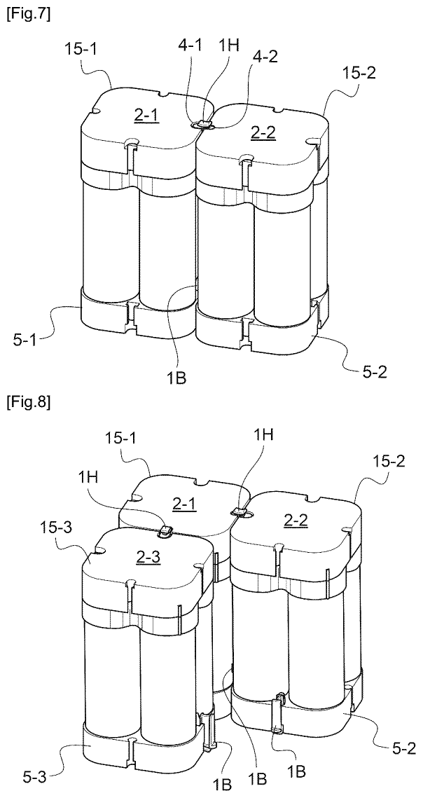

In a preferred embodiment, each module comprises four electrochemical cells secured by a flange of square shape, with optionally rounded corners, the four sides of the square each receiving a recess. FIG. 4 is a bottom view of an assembly (11) of two modules (2-1, 2-2) of this type adjoined and assembled by the clip according to the invention. It shows in particular the different cross-sections of the recesses (4-1, 4-2) made on the lateral surfaces facing the flanges (5-1, 5-2) of the two modules. Two recesses located on two opposite sides have different cross-sections. The recess (4-2) of the flange of the left module (2-2) has a T-shaped cross-section. The recess (4-1) of the flange of the right module (2-1) has a circular-shaped cross-section. FIG. 4 shows that the first portion (3) of the clip of circular-shaped cross-section is inserted into the recess of circular-shaped cross-section (4-1) of the flange of the right module. The second portion (7) of the clip of T-shaped cross-section is inserted into a recess of T-shaped cross-section (4-2) of the flange of the left module. Each flange can be equipped on its lateral surface with a mistake-proofing device in the form of an embossment (300-2 on the flange 5-2 and 300-1 on the flange 5-1) such that no error of 90° in the orientation of the modules is possible. Other flanges (15-1 and 15-2 in FIGS. 7 to 11) located at the opposite end of the electrochemical cells can also be provided with this embossment positioned in the same corner as these flanges 5-1 and 5-2. The presence of this embossment indicates to an operator a single orientation of the modules. Specifically, in the absence of this embossment, as each flange has two recesses of the same cross-section on two perpendicular sides, an operator would have the choice between two possible orientations of the flange when it comes to putting a first recess having a cross-section of a given shape face-to-face with a second recess of another flange having a cross-section of different shape. These two orientations differ from one another by an angle of rotation of 90° about the longitudinal axis of the module. The presence of the embossment in one of the corners makes it possible to indicate a single orientation of the flange. The operator can therefore no longer hesitate between one of the two orientations of the flange. It can be seen on FIG. 4 that the two modules are oriented such that the bosses are both located in the upper left corner. The flanges defined with their recesses 4-1 and 4-2 disposed face-to-face, if placed on tools coupled to the recesses, guarantee, in collaboration with the mistake-proofing of the clip, a single orientation of the modules.

The heel serves as a stop during the insertion of the clip into the common groove formed by bringing the two recesses (4-1, 4-2) of the two flanges face-to-face.

One of the advantages of the flange used in the invention is that its lateral surface is devoid of any protruding part, which makes it possible to minimize the space between two neighboring modules and therefore to optimize the compactness of the set of modules.

Variability is sometimes observed in the distance between the central axes of two modules attached to a support, a distance also known as the center-to-center distance. This variability in the center-to-center distance could create mechanical stresses if a conventional bonding jumper were used for the assembly of the modules. The invention makes it possible to avoid the formation of these stresses, by making provision for a clearance in both dimensions X and Y of a horizontal plane between the clip and one of the two flanges. In addition, variability is also sometimes observed in the height of the modules. This variability can lead to a height offset between the modules after they have been attached to a support. This height offset could once again cause stresses to appear if a conventional bonding jumper were used. The invention makes it possible to absorb these height differences by making provision for a clearance in the vertical direction. The first or the second portion of the clip is dimensioned such that there is a clearance between this first or second portion and the recess into which this portion is inserted. This clearance is present in the three dimensions of the space and thus makes it possible to compensate for the variation in center-to-center distance or the variation in height of the modules. The position of one of the two modules can slightly vary in a horizontal plane and in a vertical direction, within the limits imposed by the clearance existing between the portion of the clip and the flange of this module. The clearance can be in the order of at least 0.15 mm and less than 1 mm in each of the three dimensions of the space.

FIG. 3 is a bottom view of the area of adjoining of two modules. In particular, it shows the clearance (12) in a horizontal plane X-Y between the second portion (7) of the clip, the section of which is T-shaped, and the recess (4-2) of the flange (5-2) into which this portion is inserted. The left flange (5-2), and therefore the left module, is slightly movable in the horizontal plane X-Y and in the vertical direction due to the presence of the clearance. The right flange (5-1), and therefore the right module, is fixed given the absence of clearance in the horizontal plane and in the vertical direction between the first portion (3) of the clip and the flange (5-1).

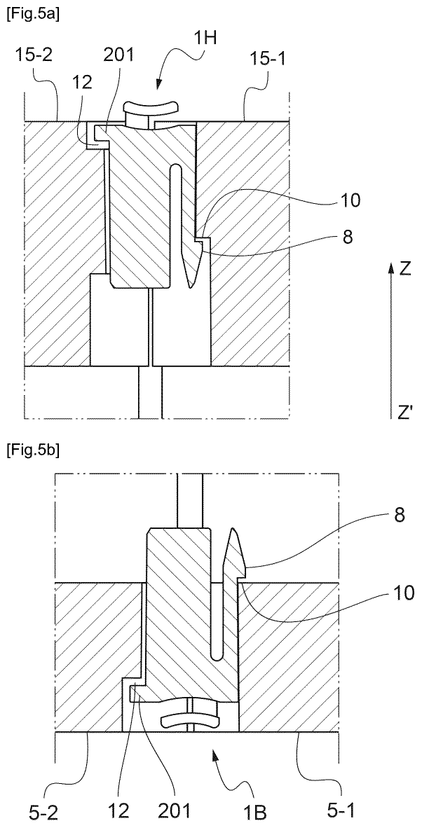

The clip can be snap-fitted through the top of a flange covering the upper end of the electrochemical cells of the module or through the bottom of a flange covering the lower end of the electrochemical cells of the module. FIG. 5a shows a longitudinal section view of a clip (1H) assembling two flanges (15-1, 15-2) disposed at the upper end of two modules. FIG. 5b shows a longitudinal section view of a clip (1B) assembling two flanges (5-1, 5-2) disposed at the lower end of two modules. In these two figures, a clearance (12) is noted in the vertical direction Z-Z′ between the heel (201) of the clip and the inner wall of the flange, thus allowing the left flange (5-2) and thus the left module to move slightly in the vertical direction. The left module is therefore slightly movable with regard to the clip whereas the right module is fixed with regard to the clip. The clip allows an assembly of two modules while allowing a certain variability in the height of the modules.

One of the advantages of the clip is that once inserted between two flanges, it can no longer become spontaneously dislodged. Specifically, one of the two portions of the clip includes a protrusion (8) which is pressed against a shoulder (10) of the flange preventing any upward vertical movement of the clip with regard to this flange. In addition, the heel of the clip serves as a stop preventing any downward vertical movement of the clip. The clip can however be removed after having been punctured.

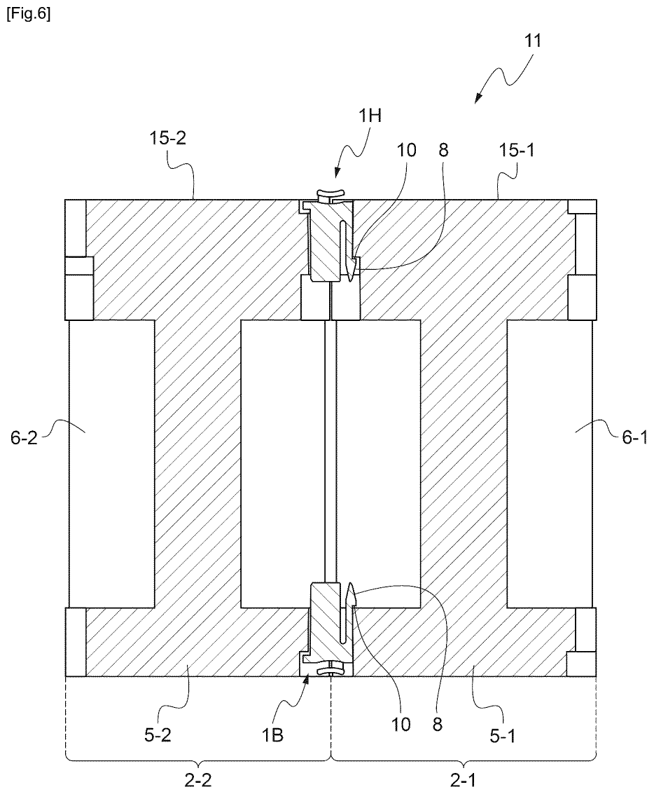

The use of a single clip on a single one of the ends of the electrochemical cells does not allow for a definitive assembly of the modules. Specifically, in the case of a single connecting element, for example at the upper end of the cells, it is possible to remove the module located on the side of the portion of the clip not including the protrusion by sliding the module downward. The use of a second clip on the opposite end of the electrochemical cells allows for a definitive assembly of the two modules. FIG. 6 shows a set (11) of two modules (2-1, 2-2). Each module is the result of the association and electrical connection of several electrochemical cells (6-1, 6-2). Each module includes an upper flange (15-1, 15-2) and a lower flange (5-1, 5-2). The two modules are assembled by their upper flanges (15-1, 15-2) by means of an upper clip (1H) and by their lower flanges (5-1, 5-2) by means of a lower clip (1B). Note that the left module (2-2) cannot become detached from the right module (2-1) since it is blocked by the heel (201) and the protrusion (8) of the second clip (1B) located on the lower part of the two modules.

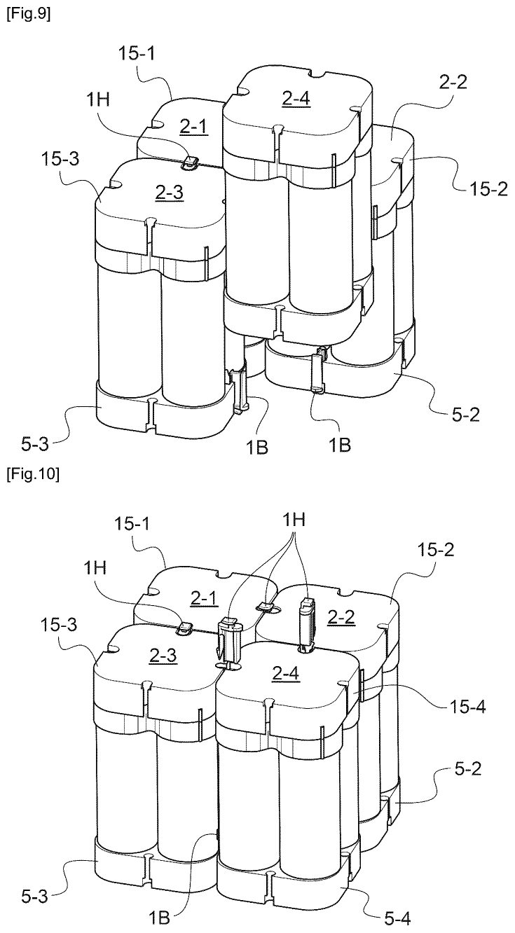

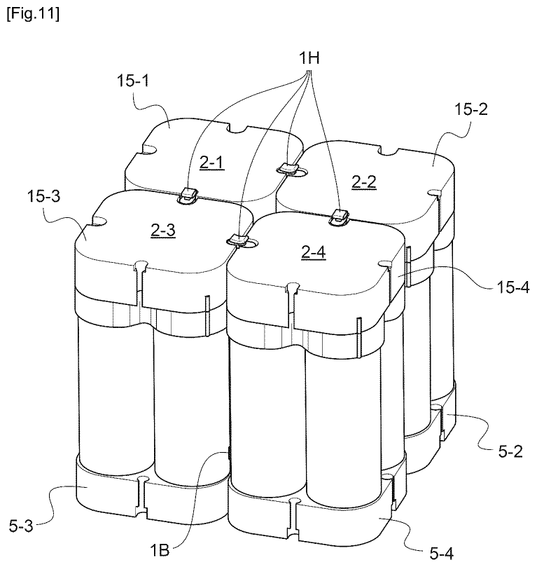

FIGS. 7 to 11 represent, in a different chronological order, different steps of the assembly of four modules (2-1, 2-2, 2-3, 2-4) each comprising four electrochemical cells. Each module is equipped with an upper flange (15-1, 15-2, 15-3, 15-4) and with a lower flange (5-1, 5-2, 5-3, 5-4). In FIG. 7, two modules (2-1, 2-2) are adjoined. The modules are oriented such that the cross-section of the cut-out of one of the recesses (4-1) is different from the cross-section of the cut-out of the recess brought face-to-face (4-2). A first (1H) and a second clip (1B) are respectively inserted into the two upper flanges and the two lower flanges thus allowing the assembly of the two modules. In FIG. 8, a third module (2-3) is adjoined against the first module (2-1). The assembly of the 3^{rd} module is carried out by inserting a clip between the upper flange (15-1) of the 1^{st} module (2-1) and the upper flange (15-3) of the 3^{rd} module. Two clips (1B) are inserted into the lower flanges of the second and the third module to make provision for the addition of a 4^{th} module. In FIG. 9, a fourth module (2-4) is inserted on the two clips located on the lower flanges (5-2, 5-3) of the 2^{nd} and of the 3^{rd} module. In FIG. 10, two additional clips (1H) are respectively inserted between the upper flanges (15-2, 15-4) of the second and of the fourth module and between the upper flanges (15-3, 15-4) of the third and of the fourth module. FIG. 11 shows the four modules assembled after insertion of these two last clips (1H).

1. A connecting part for assembling two battery modules, said connecting part comprising:
a first portion able to be inserted into a recess of a first retaining element of a first plurality of electrochemical cells forming part of a first battery module and
a second portion able to be inserted into a recess of a second retaining element of a second plurality of electrochemical cells forming part of a second battery module, the first portion and the second portion having different dimensions, such that the first portion is not suitable for being inserted into the recess of the second retaining element and/or the second portion is not suitable for being inserted into the recess of the first retaining element,
a means for preventing the removal of the connecting part after its insertion into a recess of one of the two retaining elements.

2. The connecting part as claimed in claim 1, composed of a material that does not conduct current, such as plastic.

3. The connecting part as claimed in claim 1, wherein the first portion comprises a part which is manually flexible and a part which is not manually flexible, the part which is manually flexible and the part which is not manually flexible respectively form a first and a second branch, the first and the second branch being at least partially separate, thus allowing a deformation of the part which is manually flexible with respect to the part which is not manually flexible.

4. The connecting part as claimed in claim 3, wherein the material forming the connecting part has a bending stiffness at the elastic limit at 23° C. as per the ISO standard ranging from 125 to 315 MPa.

5. The connecting part as claimed in claim 1, wherein a cross-section of the first portion is of circular or semi-circular or oval or semi-oval shape and a cross-section of the second portion is T-shaped.

6. The connecting part as claimed in claim 3, wherein a free end of the part which is manually flexible is tapered.

7. The connecting part as claimed in claim 3, wherein the means for preventing the removal of the connecting part is a protrusion located on the part which is manually flexible, suitable for snap-fitting against a shoulder of one of the retaining elements.

8. A set comprising:
a first battery module equipped with at least a first retaining element serving to retain a first plurality of electrochemical cells and a second battery module equipped with at least a second retaining element serving to retain a second plurality of electrochemical cells,
a connecting part as claimed in claim 1, assembling the first retaining element with the second retaining element, the first portion being inserted into a recess of the first retaining element and the second portion being inserted into a recess of the second retaining element,
the first portion being configured to not be able to be inserted into the recess of the second retaining element and/or the second portion being configured to not be able to be inserted into the recess of the first retaining element,
there being a clearance between the first or the second portion of the connecting part and the recess into which the first or the second portion is inserted, this clearance allowing a displacement of one of the two battery modules with respect to the other, in the three dimensions of the space.

9. The set as claimed in claim 8, wherein the clearance is of at least 0.15 mm and less than 1 mm in each of the three dimensions of the space.

10. The set as claimed in claim 8, wherein the recess of the first retaining element has at least one dimension different from the recess of the second retaining element.

11. The set as claimed in claim 8, wherein the recess of the first retaining element and the recess of the second retaining element extend along the longitudinal direction of the electrochemical cells, the shape of the cross-section of the recess of the first retaining element being different from the shape of the cross-section of the recess of the second retaining element.

12. The set as claimed in claim 11, wherein the cross-section of the recess of the first retaining element is of circular or semi-circular or oval or semi-oval shape and the cross-section of the recess of the second retaining element is T-shaped.

13. The set as claimed in claim 8, wherein:
the first and the second retaining element cover a first end of the first plurality and of the second plurality of electrochemical cells respectively,
the first connecting part connects the first and the second retaining element located at the same first end of the electrochemical cells,
the set further comprising:
a first and a second retaining element of the second end covering the opposite end of the first plurality and of the second plurality of electrochemical cells respectively,
a second connecting part connecting the first and the second retaining element of the second end.

14. The set as claimed in claim 13, wherein the first and the second connecting part each have a heel preventing the detachment of the first and of the second battery module.

15. The set as claimed in claim 13, wherein the first and the second battery module contain four electrochemical cells, the retaining elements being of square shape, with optionally rounded corners, the four sides of the square each receiving a recess.

16. The set as claimed in claim 15, wherein two recesses located on two opposite sides of the square have different dimensions and shapes.

17. A battery comprising at least one set as claimed in claim 8.
